(19) United States
(12) Patent Application Publication
(10) Pub. No.: US 2019/0172398 A1
(43) Pub. Date: Jun. 6, 2019

(54) LUMINANCE CONTROLLER, DISPLAY DEVICE HAVING THE SAME, AND METHOD FOR DRIVING DISPLAY DEVICE

(71) Applicant: Samsung Display Co., Ltd., Yongin-si (KR)

(72) Inventors: Ki Won Shin, Yongin-si (KR); Ji Hye Shin, Yongin-si (KR); Seung Ho Park, Yongin-si (KR)

(21) Appl. No.: 16/210,470

(22) Filed: Dec. 5, 2018

(30) Foreign Application Priority Data
Dec. 6, 2017 (KR) 10-2017-0166411

(51) Int. Cl. G09G 3/3266; G09G 3/3275

(52) U.S. Cl. CPC G09G 3/3266; G09G 3/3275; G09G 2320/103; G09G 2300/0439; G09G 2320/0233; G09G 2310/08

(57) ABSTRACT

A luminance controller including: a luminance calculator for calculating an average luminance of each of pixel blocks obtained by dividing a display panel, based on image data of a current frame; a pop-up detector for detecting an image pop-up by determining a number of luminance change blocks between a previous frame and the current frame among the pixel blocks; and a tone map controller for controlling a change in tone map curve of a gray scale of the image data, based on the detected result of the pop-up detector.

### CROSS-REFERENCE TO RELATED APPLICATION

The present application claims priority from and the benefit of Korean patent application 10-2017-0166411, filed on Dec. 6, 2017, which is hereby incorporated by reference for all purposes as if fully set forth herein.

### BACKGROUND

### Field

Exemplary embodiments of the invention relate generally to a display device, and more specifically, to a luminance controller, a display device having the same, and a method for driving the display device.

### Discussion of the Background

Display devices may be implemented as organic light emitting display devices in which pixels are formed using organic light emitting didoes (OLEDs). An organic light emitting display device includes two electrodes and an organic emitting layer located between the two electrodes. In the organic light emitting display device, electrons injected from one electrode and holes injected from the other electrode are combined in the organic emitting layer so as to form excitons, and the excitons emit light through energy emission.

Recently, display devices have realized images having a high contrast ratio in order to increase the stereoscopic effect of images and produce images almost identical to those viewed with the eyes of an actual person, and research and development for expressing images having a high contrast ratio have been conducted.

The above information disclosed in this Background section is only for understanding of the background of the inventive concepts, and, therefore, it may contain information that does not constitute prior art.

### SUMMARY

Exemplary embodiments provide a luminance controller for controlling a tone map curve by detecting a pop-up image.

Exemplary embodiments also provide a display device having the luminance controller.

Exemplary embodiments also provide a method for driving the display device.

Additional features of the inventive concepts will be set forth in the description which follows, and in part will be apparent from the description, or may be learned by practice of the inventive concepts.

An exemplary embodiment of the invention provides a luminance controller including: a luminance calculator configured to calculate an average luminance of each of pixel blocks obtained by dividing a display panel, based on image data of a current frame; a pop-up detector configured to detect an image pop-up by determining a number of luminance change blocks between a previous frame and the current frame among the pixel blocks; and a tone map controller configured to control a change in a tone map curve of a gray scale of the image data, based on the detected result of the pop-up detector.

The pop-up detector may compare the number of luminance change blocks with a preset pop-up range. When the number of luminance change blocks is included in the pop-up range, the pop-up detector may determine that the image pop-up has occurred in the current frame, and output a pop-up signal.

The tone map controller may gradually change the tone map curve of the previous frame to a target tone map curve throughout a plurality of frame periods in response to the pop-up signal.

The tone map controller may maintain the tone map curve of the previous frame regardless of a change in the image data during a preset frame period in response to the pop-up signal.

The luminance controller may further include an image compensator configured to update the tone map curve that expands a luminance range, based on an average luminance of each of preset gray scale sections of the image data on the entire image of the current frame.

When the number of luminance change blocks is included in the preset pop-up range, the tone map controller may adjust a variation in the tone map curve by controlling the image compensator.

When the number of luminance change blocks is out of the pop-up range, the tone map controller may not be operated, and the image compensator may generate the tone map curve.

Another exemplary embodiment of the invention provides a display device including: a display panel divided into pixel blocks each including a plurality of pixels; a display panel driver configured to drive the display panel to display an image, based on image data; and a luminance controller configured to detect an image pop-up, based on a change in average image information of each of the pixel blocks, and control a tone map curve of the image data, based on the image pop-up.

The luminance controller may include: a luminance calculator configured to calculate average image information of each of the pixel blocks, based on the image data of a current frame; a pop-up detector configured to detect the image pop-up by determining a number of image change blocks between a previous frame and the current frame among the pixel blocks; and a tone map controller configured to control a change of the tone map curve, based on the detected result of the pop-up detector.

The average image information may be an average luminance of each of the pixel blocks.

The average image information may be an average chrominance of each of the pixel blocks.

When the number of image change blocks is included in a preset pop-up range, the pop-up detector may determine that the image pop-up has occurred in the current frame, and output a pop-up signal.

The tone map controller may gradually change a tone map curve of the previous frame to a target tone map curve throughout a plurality of frame periods in response to the pop-up signal.

The target tone map curve may expand or reduce a luminance range, based on an average luminance of each of preset gray scale sections of the image data.

The tone map controller may maintain the tone map curve of the previous frame regardless of a change in the image data in response to the pop-up signal.

Another exemplary embodiment of the invention provides a method for driving a display device, the method including: calculating average image information of each of a plurality of pixel blocks from image data; counting a number of image change blocks by comparing average image information of each of the pixel blocks between a previous frame and a current frame; detecting an image pop-up by comparing the number of image change blocks with a preset pop-up range; when the number of image change blocks is out of the pop-up range, updating a tone map curve of the previous frame to a target tone map curve, based on the image data on the entire image of the current frame; and when the number of image change blocks is included in the pop-up range, suppressing a change in the tone map curve of the previous frame.

In the suppressing of a change in the tone map curve, the tone map curve of the previous frame may be gradually changed to the target tone map curve throughout a plurality of frame periods.

In the suppressing of a change in the tone map curve, the tone map curve of the previous frame may be maintained during a plurality of preset frame periods regardless of a change in the image data.

The average image information may be an average luminance of each of the pixel blocks.

The average image information may be an average chrominance of each of the pixel blocks.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a block diagram illustrating a display device according to exemplary embodiments of the invention.

FIG. 2A is a diagram illustrating an example of a display panel included in the display device of FIG. 1.

FIG. 2B is a diagram illustrating an example in which a pop-up image is displayed on the display panel of FIG. 2A.

FIG. 3 is a block diagram illustrating a luminance controller according to exemplary embodiments of the invention.

FIG. 4 is a block diagram illustrating an example of the luminance controller of FIG. 3.

FIG. 5 is a graph illustrating an example of a change in tone map curve as frames elapse.

FIG. 6 is a graph illustrating another example of the change in tone map curve as frames elapse.

FIG. 7 is a diagram illustrating an example of an operation of the luminance controller of FIG. 3.

FIG. 8 is a flowchart illustrating a method for driving the display device according to exemplary embodiments of the invention.

### DETAILED DESCRIPTION

In the following description, for the purposes of explanation, numerous specific details are set forth in order to provide a thorough understanding of various exemplary embodiments of the invention. As used herein “embodiments” are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

In the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

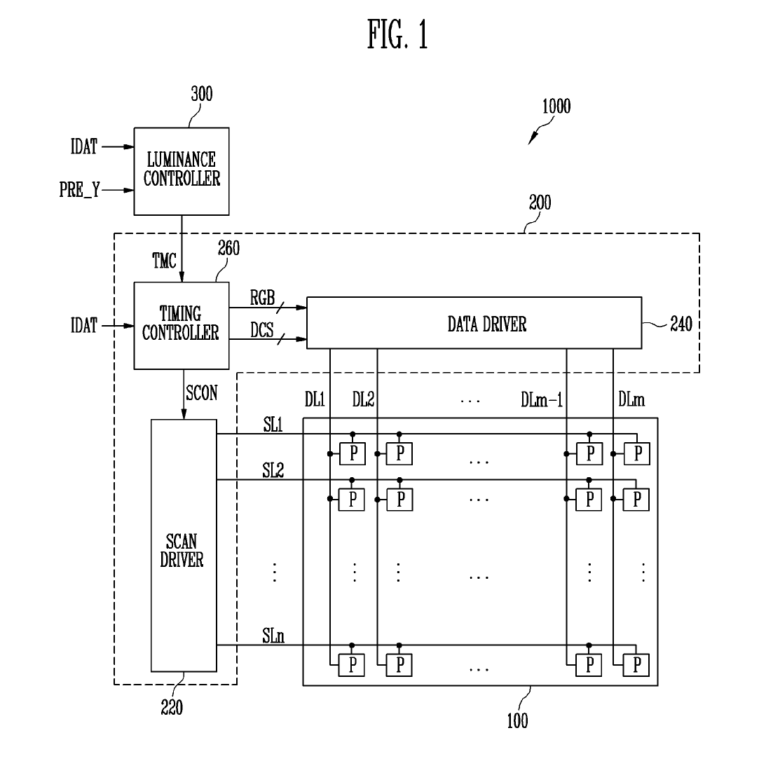

FIG. 1 is a block diagram illustrating a display device according to exemplary embodiments of the invention.

Referring to FIG. 1, the display device 1000 may include a display panel 100, a display panel driver 200, and a luminance controller 300.

The display device 1000 may be implemented as an organic light emitting display device, a liquid crystal display device, or the like. The display device 1000 may be a flat panel display device, a flexible display device, a curved display device, a foldable display device, or a bendable display device. Also, the display device 1000 may be applied to a transparent display device, a head-mounted display device, a wearable display device, and the like.

The display panel 100 may include a plurality of scan lines SL1 to SLn and a plurality of data lines DL1 to DLm, and may include a plurality of pixel P coupled to the scan lines SL1 to SLn and the data lines DL1 to DLm (here, n and m are integers of 1 or more). Each of the pixels P may include a driving transistor and a plurality of switching transistors. In an exemplary embodiment, each of the pixels P includes an organic light emitting diode, and may be implemented as one of red, green, and blue pixels.

However, this is merely illustrative, and the configuration of each of the pixels P is not limited thereto. For example, each of the pixels P may be any one of a red pixel, a green pixel, a blue pixel, and a white pixel, or be any one of a magenta pixel, a cyan pixel, and a yellow pixel.

In an exemplary embodiment, the display panel 100 may be divided into a plurality of pixel blocks each including a plurality of pixels P. For example, the pixel block may have a quadrangular shape. Also, the display panel 100 may be divided into pixel blocks of 4×8 (width×length). However, this is merely illustrative, and the shape and number of pixel blocks are not limited thereto.

The pixel blocks may all have the same number of pixels P, and the number of pixels P included in one pixel block may be different from that of pixels P included in the other pixel blocks.

The display panel driver 200 may drive the display panel 100 to display an image, based on image data IDAT. In an exemplary embodiment, the display panel driver 200 may include a scan driver 220, a data driver 240, and a timing controller 260.

The scan driver 220 may supply a scan signal to the pixels P through the scan lines SL1 to SLn in response to a scan control signal SCON. The scan driver 220 receives the scan control signal SCON, a least one clock signal, and the like from the timing controller 260. In an exemplary embodiment, if a scan signal is supplied to a first scan line SL1, the pixels P may be sequentially selected in units of horizontal lines. To this end, the scan signal may be set to a gate-on voltage at which transistors included in the pixels P can be turned on. For example, when the transistors included in the pixels P are P-channel metal oxide semiconductor PMOS transistors, the gate-on voltage may be set to a logic high level.

The data driver 240 may receive a data control signal DCS and an image data signal RGB from the timing controller 260. The data driver 240 may supply a data signal to the pixels P through the data lines DL1 to DLm in response to the data control signal DCS and the image data signal RGB. In an exemplary embodiment, in one frame, the data driver 240 may supply the data signal to the data lines DL1 to DLm to be synchronized with the last scan signal of each of the scan lines SL1 to SLn among scan signals supplied to each of the scan lines SL1 to SLn.

The timing controller 260 may control driving of the scan driver 220 and the data driver 240 in response to timing signals supplied from the outside. The timing controller 260 may supply a control signal including the scan control signal SCON, a scan clock signal, and the like to the scan driver 220. The data control signal DCS for controlling the data driver 240 may include a source start signal, a source output enable signal, a source sampling clock, and the like.

Meanwhile, the display panel driver 200 may further include an emission driver for controlling whether the pixels P emit light by supplying an emission control signal to the pixels P, a power supply unit for supplying a driving voltage, a power voltage, an initialization voltage, and the like to the display panel 100, and the like.

The luminance controller 300 may detect an image pop-up, based on a change in average image information of each of the pixel blocks, and control a tone map curve TMC of the image data IDAT, based on the image pop-up. In an exemplary embodiment, the luminance controller 300 may be physically included in the timing controller 260.

Data information including a tone map curve TMC may be provided to the timing controller 260, and image data IDAT or a luminance component of the image data IDAT may be compensated as a predetermined value, based on the tone map curve TMC. The tone map curve TMC may be a luminance curve generated by analyzing image data IDAT of a current frame. For example, average luminances of present gray scale sections may be calculated based on the image data IDAT of the current frame, and the luminance range of the image data IDAT may be adaptively expanded or reduced according to the average luminances of the gray scale sections. The luminance range may be expressed as a high dynamic range (HDR) for realizing a high contrast ratio of images, and provide an image effect that maximizes image contrast to an optimum state.

The luminance controller 300 may detect average image information of the pixel blocks by analyzing the image data IDAT of the current frame. In an exemplary embodiment, each of the average image information may be an average luminance of each of the pixel blocks. The average luminance may be calculated by averaging luminance components included in image data IDAT corresponding to each pixel block. Also, in an exemplary embodiment, each of the average image information may be an average chrominance of each of the pixel blocks. For example, the average chrominance may be calculated by averaging chrominance components included in image data corresponding to each pixel block. As an example, the chrominance component may be set to a predetermined coordinate value on a color coordinate system.

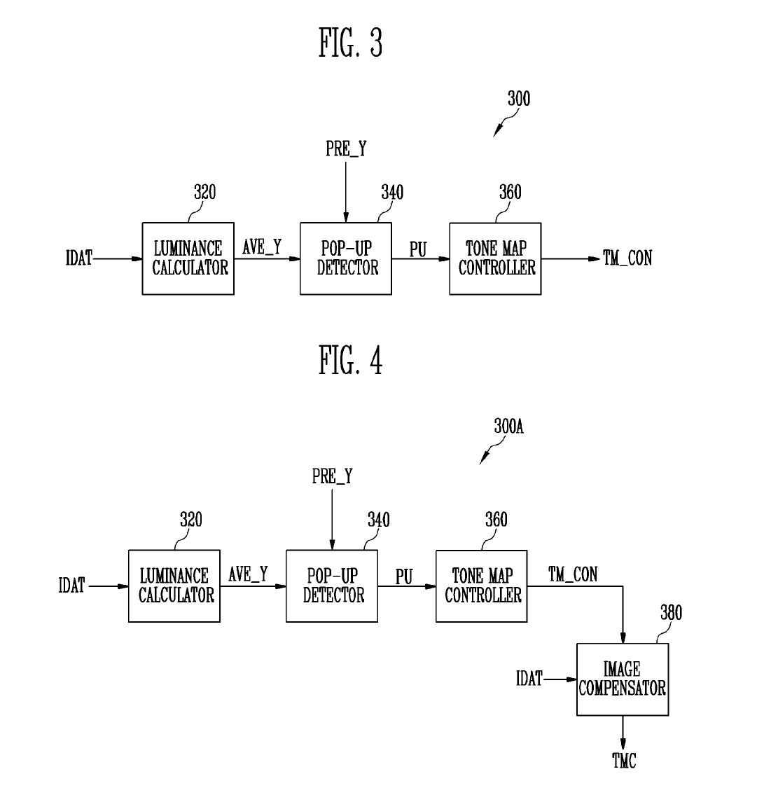

The luminance controller 300 may detect an image change by comparing average image information of a previous frame, e.g., an average luminance PRE_Y of each of the pixel blocks in the previous frame with the average image information of the current frame. Also, the luminance controller 300 may detect the pop-up of an image, based on the number of image change blocks. The luminance controller 300 may control a tone map curve TMC according to the detected result of the image pop-up. The operation and configuration of the luminance controller 300 will be described in detail with reference to FIGS. 3 to 7.

The display device 1000 according to the exemplary embodiments of the invention can detect an image pop-up event by analyzing image changes in units of pixel blocks. If an image pop-up event occurs, the luminance controller 300 restricts HDR driving by suppressing a change in the tone map curve, so that a change in contrast can be restricted during the occurrence of an image pop-up. Accordingly, visual inconvenience caused by the HDR driving can be reduced during the occurrence of an image pop-up, and a user can view a natural image.

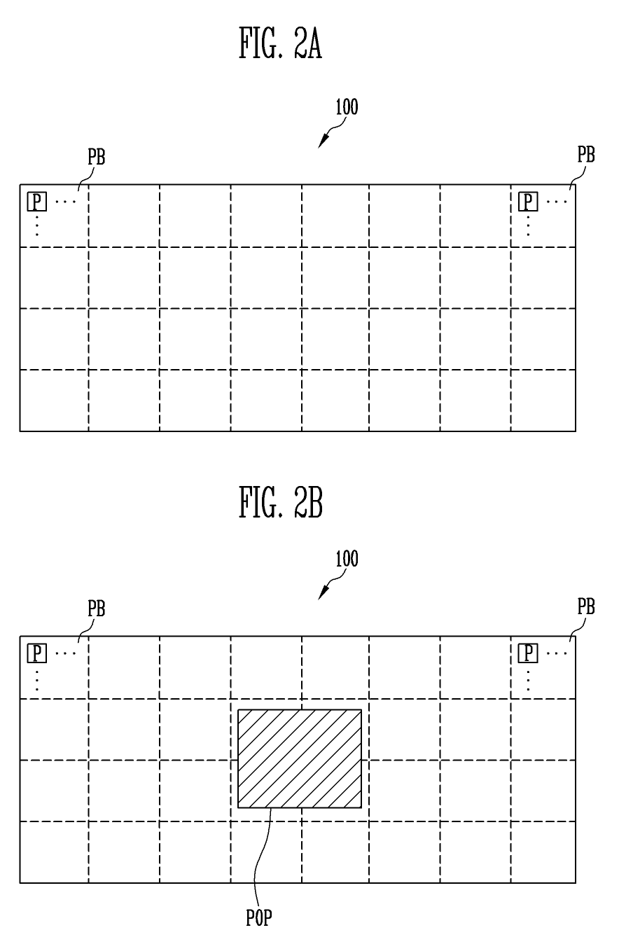

FIG. 2A is a diagram illustrating an example of the display panel included in the display device of FIG. 1. FIG. 2B is a diagram illustrating an example in which a pop-up image is displayed on the display panel of FIG. 2A.

Referring to FIGS. 1 to 2B, the display panel 100 may include a plurality of pixel blocks PB each including a plurality of pixels P.

In an exemplary embodiment, the pixel blocks PB may have a quadrangular shape. As shown in FIGS. 2A and 2B, the display panel 100 may be divided into pixel blocks PB of 4×8 (width×length). That is, the display panel 100 may be divided into a total of 32 pixel blocks PB. However, this is merely illustrative, and the shape and number of pixel blocks are not limited thereto.

The pixel blocks may all have the same number of pixels P, and the number of pixels P included in one pixel block may be different from that of pixels P included in the other pixel blocks.

The luminance controller 300 may calculate average image information corresponding to each of the pixel blocks PB by analyzing image data IDAT.

As shown in FIG. 2B, a pop-up image POP may be displayed as an image pop-up event. In the pixel block PB in which the pop-up image POP is displayed, average image information of a previous frame and average image information of a current frame are different from each other. For example, the average image information may be an average luminance or average chrominance in a corresponding pixel block of a corresponding frame. The luminance controller 300 may calculate a variation in average image information for each pixel block PB between the consecutive frames. When the variation in average image information exceeds a preset threshold reference, the luminance controller 300 may determine the pixel block as an image change block.

The pop-up image POP includes a message pop-up, a banner, an advertisement pop-up, and the like, and may occupy only a portion of a display area in which the display panel 100 displays an image. For example, as shown in FIG. 2B, the pop-up image POP may be displayed in four pixel blocks PB adjacent to each other at the center of the display panel 100. That is, the pixel blocks PB including the pop-up image POP may correspond to image change blocks. However, this is merely illustrative, and the size and position of the pop-up image are not limited thereto.

The luminance controller 300 may determine whether an image pop-up has occurred according to the number of image change blocks. In an exemplary embodiment, when the number of image change blocks is included in a preset pop-up range, it may be determined that a pop-up image is displayed in the corresponding image change blocks. For example, the pop-up range may correspond to a range from one pixel block PB to a half of the total number of pixel bocks. As an example, when there is no image change block, it may be determined that a corresponding image is a still image, and it may be determined that any image pop-up event does not occur. In addition, when an image change block exceeds 50% of the total pixel blocks PB (in FIG. 2, the number of image change blocks exceeds 16), it may be determined that a corresponding image is switched to a moving image or another image, and it may be determined that any image pop-up event does not occur. However, this is merely illustrative, and the pop-up range is not limited thereto. The pop-up range may be set to an optimum value according to various factors including a product to which the display panel 100 is applied, a usage of the product, a size of the product, a shape of the product, etc.

Further, even when the number of image change blocks that are spaced apart from each other is included in the pop-up range, it may be determined that an image pop-up has occurred.

As described above, the luminance controller 300 can relatively accurately determine whether an image pop-up event has occurred based on a variation in average image information of each of the pixel blocks PB between the consecutive frames

FIG. 3 is a block diagram illustrating a luminance controller according to exemplary embodiments of the invention.

The luminance controller 300 of FIG. 3 may include substantially the same or similar configurations and operations as the luminance controller 300 of FIG. 1.

Referring to FIG. 3, the luminance controller 300 may include a luminance calculator 320, a pop-up detector 340, and a tone map controller 360.

The luminance calculator 320 may calculate an average luminance AVE_Y of each of the pixel blocks, based on image data IDAT of a current frame. The average luminance AVE_Y may be calculated by averaging luminance components of the image data IDAT corresponding to each of the pixels included in the pixel block. However, this is merely illustrative, and an average chrominance of each of the pixel blocks may be calculated based on chrominance components included in the image data IDAT in another exemplary embodiment.

In an exemplary embodiment, the average luminance AVE_Y may be stored in an external memory, a register, or the like. The calculated average luminance AVE_Y may be provided to the pop-up detector 340.

The pop-up detector 340 may detect an image pop-up by determining a number of luminance change blocks between a previous frame and the current frame among the pixel blocks. In an embodiment, the pop-up detector 340 may compare an average luminance PRE_Y of the previous frame and an average luminance AVE_Y of the current frame for each of the pixel blocks. When a variation in average luminance calculated by comparing the average luminances exceeds a predetermined threshold reference, the corresponding pixel block may be determined as a luminance change block.

The pop-up detector 340 may calculate the number of luminance change blocks. The pop-up detector 340 may detect whether an image pop-up has occurred by comparing the number of luminance change blocks with a preset pop-up range. In an exemplary embodiment, the pop-up range may correspond to a range from one pixel block to a half of the total number of pixel bocks. However, this is merely illustrative, and the pop-up range is not limited thereto.

In an exemplary embodiment, when the number of luminance change blocks exists within the pop-up range, the pop-up detector 340 may determine whether an image pop-up has occurred in the current frame and output a pop-up signal PU. The pop-up signal PU may be transferred to the tone map controller 360 to control driving of the tone map controller 360.

In an exemplary embodiment, when the number of luminance change blocks is out of the pop-up range, the pop-up detector 340 does not output the pop-up signal PU. That is, if the number of luminance change blocks is out of the pop-up range, the pop-up detector 340 may determine that any image pop-up does not occur. In this case, a target tone map curve corresponding to the image data IDAT of the current frame may be output. That is, when any image pop-up does not occur, normal HDR driving may be performed.

The tone map controller 360 may control a change in tone map curve of a gray scale of the image data IDAT, based on the detected result of the pop-up detector 340. For example, the tone map controller 360 may output a tone map control signal TM_CON for controlling/adjusting a tone map curve.

In an exemplary embodiment, the tone map controller 360 may gradually change a tone map curve of the previous frame to the target tone map curve throughout a plurality of frame periods in response to the pop-up signal PU. Accordingly, when a change in the entire image (e.g., a background image) occurs after the image pop-up occurs, the contrast of the image can be gently changed throughout a plurality of frames.

In a conventional HDR driving method, the adjustment of contrast is performed by analyzing only luminance for each gray scale section without analyzing an image for each pixel block. Therefore, in the conventional HDR driving method, although an image pop-up occurs, the contrast is adjusted without recognizing the image pop-up. Hence, a user may feel visual inconvenience as the pop-up image is not clearly viewed.

However, the luminance controller 300 according to the exemplary embodiments detects an image pop-up, and thus a rapid change in tone map curve, caused by adaptive HDR driving corresponding to the image pop-up, can be suppressed. Accordingly, the image quality in the occurrence of an image pop-up can be improved.

In an embodiment, the tone map controller 360 may maintain the tone map curve of the previous frame through a preset frame period in response to the pop-up signal PU. That is, when an image pop-up occurs, the tone map controller 360 maintains the tone map curve of the previous frame regardless of the change in image data IDAT. Thus, a rapid change in contrast can be suppressed, and the image quality in the occurrence of an image pop-up can be improved.

FIG. 4 is a block diagram illustrating an example of the luminance controller of FIG. 3.

In FIG. 4, components identical to those described with reference to FIG. 3 are designated by like reference numerals, and their overlapping descriptions will be omitted. In addition, the luminance controller 300A of FIG. 4 may have a configuration substantially identical or similar to the luminance controller 300 of FIG. 3, except an image compensator 380.

Referring to FIG. 4, the luminance controller 300A may include a luminance calculator 320, a pop-up detector 340, a tone map controller 360, and an image compensator 380.

The luminance calculator 320 may calculate an average luminance AVE_Y of each of the pixel blocks, based on image data IDAT of a current frame.

The pop-up detector 340 may detect an image pop-up by determining the number of luminance change blocks between a previous frame and the current frame among the pixel blocks.

In an exemplary embodiment, when the number of luminance change blocks exists within the pop-up range, the pop-up detector 340 may determine whether an image pop-up has occurred in the current frame and output a pop-up signal PU. The pop-up signal PU may be transferred to the tone map controller 360 to control driving of the tone map controller 360. In an embodiment, when the number of luminance change blocks is out of the pop-up range, the pop-up detector 340 does not output the pop-up signal PU. Therefore, when any image pop-up is not detected, the tone map controller 360 is not operated.

The tone map controller 360 may control a change in tone map curve of a gray scale of the image data IDAT, based on the detected result of the pop-up detector 340. For example, the tone map controller 360 may output a tone map control signal TM_CON for controlling a change in tone map curve.

The image compensator 380 may update a tone map curve TMC using image data IDAT on the entire image of the current frame. For example, the tone map curve TMC may expand or reduce the luminance range in a corresponding gray scale, based on the average luminance of each of the preset gray scale sections of the image data IDAT. That is, the luminance component of the image data may be compensated by the tone map curve TMC, and the contrast may be adjusted to an optimum value by the tone map curve TMC.

In an exemplary embodiment, the operation of the image compensator 380 may be controlled by a tone map control signal TM_CON. When the number of luminance change blocks is out of the pop-up range (i.e., when any image pop-up is not detected), the image compensator 380 may generate or update the tone map curve TMC, using only the image data IDAT of the current frame. Thus, adaptive HDR driving can be optimized and performed.

On the other hand, when the number of luminance change blocks is included in the pop-up range, a variation in tone map curve may be adjusted by the tone map control signal TM_CON. That is, the image compensator 380 may output a target tone map curve determined by the image data IDAT of the current frame in response to the tone map control signal TM_CON. For example, the image compensator 380 may gradually change the tone map curve from a previous tone map curve to the target tone curve throughout a plurality of frame periods. Accordingly, when a change in the entire image (e.g., a background image) occurs after the image pop-up occurs, the contrast of the image can be gently changed throughout a plurality of frames.

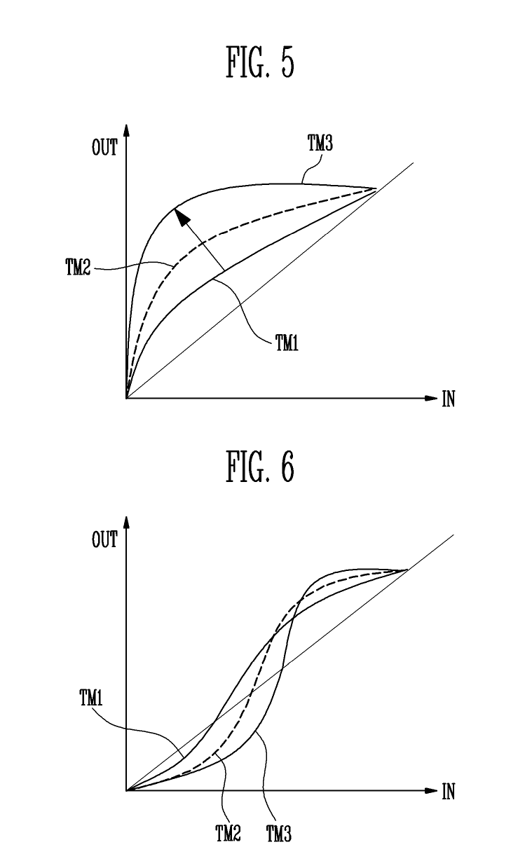

FIG. 5 is a graph illustrating an example of a change in tone map curve as frames elapse. FIG. 6 is a graph illustrating another example of the change in tone map curve as frames elapse.

Referring to FIGS. 5 and 6, when an image pop-up is detected, a tone map curve may be gradually changed to a target tone map curve throughout a plurality of frames.

Tone map curves of FIGS. 5 and 6 represent luminance information corresponding to a gray scale of compensated output image data with respect to luminance information corresponding to a gray scale of input image data.

In an exemplary embodiment, the tone map curve may be changed in an order of TM1→TM2→TM3 as frames elapse. In an exemplary embodiment, TM3 may be a target tone curve, and TM1 may be a tone map curve of a previous frame. Accordingly, when an image pop-up occurs, the contrast of an image can be gently changed as frames elapse.

As shown in FIG. 5, the target tone map curve TM3 may be C-type tone map curve. In this case, images having a middle gray scale or higher are displayed brighter than the original image, and therefore, the contrast of the images may be reinforced.

As shown in FIG. 6, the target tone map curve TM3 may be an S-type tone map curve. In this case, a dark image is displayed darker than the original image, and a bright image is displayed brighter than the original image. Therefore, the contrast of the images may be reinforced.

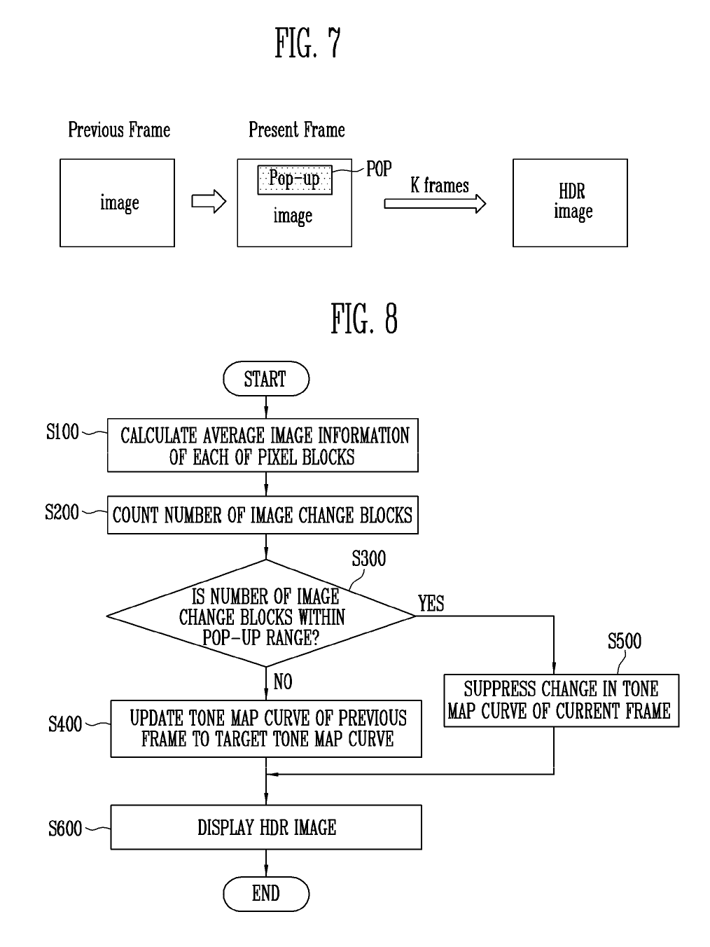

FIG. 7 is a diagram illustrating an example of the operation of the luminance controller of FIG. 3.

Referring to FIG. 7, when an image pop-up occurs, a change in tone map curve may be suppressed during a predetermined frame period.

In a previous frame, a tone map curve may be determined based on image data of the previous frame, and an HDR image may be displayed based on the tone map curve.

When a pop-up image POP is displayed in a current frame, the update (or change) of a tone map curve may be controlled. In an exemplary embodiment, the tone map curve may be maintained without any change during a plurality of frame periods. In another embodiment, the tone map curve may be gradually changed to a target tone map curve during a plurality of frame periods.

If a plurality of preset frame periods elapse after the pop-up image is displayed, an HDR image may be displayed based on the target tone map curve.

Accordingly, a rapid change in tone map curve, caused by adaptive HDR driving corresponding to the image pop-up, can be suppressed. Thus, the image quality in the occurrence of an image pop-up can be improved.

FIG. 8 is a flowchart illustrating a method for driving the display device according to exemplary embodiments of the invention.

Referring to FIG. 8, in the method, average image information of each of a plurality of blocks may be calculated from image data (S100), the number of image change blocks may be counted by comparing average image information of each of the pixel blocks between a previous frame and a current frame (S200), and an image pop-up may be detected by comparing the number of image change blocks with a preset pop-up range (S300). Also, in the method, when the number of image change blocks is out of the pop-up range, a tone map curve of the previous frame may be updated to a target tone map curve, based on image data on the entire image of the current frame (S400). On the other hand, in the method, when the number of image change blocks exists within the pop-up range, a change in the tone map curve of the previous frame may be suppressed (S500).

Average image information of each of the plurality of pixel blocks may be calculated from image data (S100). In an exemplary embodiment, the average image information may be an average luminance of each of the pixel blocks. In another exemplary embodiment, the average image information may be an average chrominance of each of the pixel blocks.

The number of image change blocks may be counted by comparing average image information of each of the pixel blocks between a previous frame and a current frame (S200), and an image pop-up may be detected based on a result obtained by the number of image change blocks with a preset pop-up range (S300).

When the number of image change blocks is out of the pop-up range, it is determined that any image pop-up does not occur. Therefore, a tone map curve of the previous frame may be updated to a target tone map curve, based on image data on the entire image of the current frame (S400).

An HDR image may be displayed based on the target tone map curve (S600).

When the number of image change blocks exists within the pop-up range, it is determined that an image pop-up has occurred. Therefore, a change of the tone map curve of the previous frame may be suppressed (S500). In an exemplary embodiment, the tone map curve of the previous frame may be gradually changed to a target tone map curve throughout a plurality of frame periods. Accordingly, the contrast of an image can be gently changed throughout a plurality of frame periods. In an exemplary embodiment, a tone map curve of the current frame may be maintained during a plurality of preset frame periods, regardless of the change in image data. Accordingly, a change in contrast can be suppressed.

An HDR image may be displayed based on the tone map curve of which change is suppressed (S600).

The method of FIG. 8 has been described with reference to FIGS. 1 to 7, and therefore, descriptions overlapping with those of FIGS. 1 to 7 were omitted.

As described above, in the method according to the inventive concepts, an image pop-up event can be detected by analyzing image changes in units of pixel blocks. If an image pop-up event occurs, HDR driving is restricted by suppressing a change in tone map curve, so that a change in contrast in the occurrence of an image pop-up can be restricted. Accordingly, visual inconvenience caused by the HDR driving can be reduced in the occurrence of an image pop-up, and a user can view a natural image.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A luminance controller comprising:
a luminance calculator configured to calculate an average luminance of each of pixel blocks obtained by dividing a display panel, based on image data of a current frame;
a pop-up detector configured to detect an image pop-up by determining a number of luminance change blocks between a previous frame and the current frame among the pixel blocks; and
a tone map controller configured to control a change in tone map curve of a gray scale of the image data, based on the detected result of the pop-up detector.

2. The luminance controller of claim 1, wherein:
the pop-up detector compares the number of luminance change blocks with a preset pop-up range; and
when the number of luminance change blocks is included in the pop-up range, the pop-up detector determines that the image pop-up has occurred in the current frame, and outputs a pop-up signal.

3. The luminance controller of claim 2, wherein the tone map controller gradually changes the tone map curve of the previous frame to a target tone map curve throughout a plurality of frame periods in response to the pop-up signal.

4. The luminance controller of claim 2, wherein the tone map controller maintains the tone map curve of the previous frame regardless of a change in the image data during a preset frame section in response to the pop-up signal.

5. The luminance controller of claim 1, further comprising an image compensator configured to update the tone map curve that expands a luminance range based on an average luminance of each of preset gray scale sections of the image data on the entire image of the current frame.

6. The luminance controller of claim 5, wherein, when the number of luminance change blocks is included in a preset pop-up range, the tone map controller adjusts a variation in the tone map curve by controlling the image compensator.

7. The luminance controller of claim 5, wherein, when the number of luminance change blocks is out of the pop-up range, the tone map controller is not operated, and the image compensator generates the tone map curve.

8. A display device comprising:
a display panel divided into pixel blocks each comprising a plurality of pixels;
a display panel driver configured to drive the display panel to display an image, based on image data; and
a luminance controller configured to detect an image pop-up based on a change in average image information of each of the pixel blocks, and control a tone map curve of the image data based on the image pop-up.

9. The display device of claim 8, wherein the luminance controller comprises:
a luminance calculator configured to calculate average image information of each of the pixel blocks, based on the image data of a current frame;
a pop-up detector configured to detect the image pop-up by determining a number of image change blocks between a previous frame and the current frame among the pixel blocks; and
a tone map controller configured to control a change of the tone map curve, based on the detected result of the pop-up detector.

10. The display device of claim 9, wherein the average image information is an average luminance of each of the pixel blocks.

11. The display device of claim 9, wherein the average image information is an average chrominance of each of the pixel blocks.

12. The display device of claim 9, wherein, when the number of image change blocks is included in a preset pop-up range, the pop-up detector determines that the image pop-up has occurred in the current frame, and outputs a pop-up signal.

13. The display device of claim 12, wherein the tone map controller gradually changes a tone map curve of the previous frame to a target tone map curve throughout a plurality of frame sections in response to the pop-up signal.

14. The display device of claim 13, wherein the target tone map curve expands or reduces a luminance range based on an average luminance of each of preset gray scale sections of the image data.

15. The display device of claim 12, wherein the tone map controller maintains the tone map curve of the previous frame regardless of a change in the image data in response to the pop-up signal.

16. A method for driving a display device, the method comprising:
calculating average image information of each of a plurality of pixel blocks from image data;
counting a number of image change blocks by comparing the average image information of each of the pixel blocks between a previous frame and a current frame;
detecting an image pop-up by comparing the number of image change blocks with a preset pop-up range;
updating a tone map curve of the previous frame to a target tone map curve based on the image data on an entire image of the current frame when the number of image change blocks is out of the pop-up range; and
suppressing a change in the tone map curve of the previous frame when the number of image change blocks is included in the pop-up range.

17. The method of claim 16, wherein, in the suppressing of a change in the tone map curve, the tone map curve of the previous frame is gradually changed to the target tone map curve throughout a plurality of frame periods.

18. The method of claim 16, wherein, in the suppressing of a change in the tone map curve, the tone map curve of the previous frame is maintained during a plurality of preset frame periods regardless of a change in the image data.

19. The method of claim 16, wherein the average image information is an average luminance of each of the pixel blocks.

20. The method of claim 16, wherein the average image information is an average chrominance of each of the pixel blocks.
